(19) United States
(12) Patent Application Publication
(10) Pub. No.: US 2002/0198980 A1
(43) Pub. Date: Dec. 26, 2002

(54) Asset management and monitoring system and method for selecting a wireless network for data transmission

(76) Inventor: Hamid Najafi, Los Altos Hills, CA (US)

Correspondence Address: SQUIRE, SANDERS & DEMPSEY L.L.P, 600 HANSEN WAY, PALO ALTO, CA, 94304-1043, US

(21) Appl. No.: 09/882,773

(22) Filed: Jun. 15, 2001

(51) Int. Cl. G06F 15/16

(52) U.S. Cl. 709/224; 709/236

(57) ABSTRACT

A remote asset management and monitoring system for selecting a network for data transmission comprises a global positioning system receiver; a wireless transceiver capable of communicating with at least two networks; a processor; and a memory device. The memory device includes an engine for performing asset management and monitoring functions. The memory device also includes a network selection engine for selecting a network using a weight score algorithm that is a function of network attributes and data segment attribute weights.

### TECHNICAL FIELD

This invention relates generally to remote asset management, and more particularly, but not exclusively, provides a system and method for selecting a wireless network for data transmission in remote asset management and/or monitoring applications.

### BACKGROUND

Remote asset management and monitoring enables corporations or other entities to remotely monitor their fixed and/or mobile assets, such as commercial trailers, through the integration of the Global Positioning System (GPS) receivers and wireless communications. To report asset-monitoring data to corporations, such as position data as determined by a GPS receiver, remote asset management/monitoring devices make use of various wireless networks, with each wireless network possibly having different attributes, such as cost and reliability. Therefore, a wireless network optimal for one remote asset management/monitoring application may not be optimal for another remote asset management/monitoring application.

For example, for an asset position reporting application, a wireless network should have attributes including security and low cost, while speed of the wireless network is not as important. In comparison, for an asset theft reporting application, a wireless network should have attributes including high speed, low latency, and high reliability, while cost is not an important attribute.

Accordingly, a system and method for selecting a wireless network for communicating data in remote asset management and monitoring applications may be highly desirable.

### SUMMARY

The present invention provides a system for selecting a wireless network for communicating data for remote asset management and monitoring applications to a monitoring station or other destination. The system comprises a GPS receiver capable to calculate position; a wireless transceiver capable to communicate via at least two different wireless networks; a memory device; and a processor capable to execute instructions in the memory device.

The memory device includes an asset management/monitoring engine capable to track an asset and perform other remote asset managing or monitoring applications; a network selection engine capable to select a wireless network as a function of multiple network attributes and data segment attribute weights; a network attributes data file including attributes of wireless networks supported by the wireless transceiver; and a data segment attribute weights file including attribute weights of different data segments types.

The present invention further provides a method for selecting a wireless network in remote asset tracking applications. The method comprises: receiving a data segment, comprising asset management and/or monitoring data, from the asset tracking engine to transmit over a wireless network; determining which wireless networks are available; determining which of the available wireless networks have sufficient bandwidth to transmit the data segment; performing a weighted scored analysis of the available wireless networks having sufficient bandwidth as a function of network attributes and data segment attribute weights; selecting a wireless network having the highest weighted score; and transmitting the data segment to the selected wireless network for transmission to a monitoring station or other destination.

The system and method may advantageously enable a remote asset tracking apparatus to select an optimum wireless network as function of network attributes and data segment attribute weights.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a diagram illustrating a remote asset management/monitoring device installed on an asset;

FIG. 2 is a block diagram illustrating the remote asset management/monitoring device of FIG. 1 according to an embodiment of the invention;

FIG. 3 is a block diagram of a memory device in the remote asset management/monitoring device;

FIG. 4 is a diagram of an example of table of network attributes for an example wireless network;

FIG. 5 is a diagram of an example data segment attribute weight list from a data segment weights file; and

FIG. 6 is a flowchart of a method for selecting a wireless network to transmit a remote asset management/monitoring data segment.

### DETAILED DESCRIPTION OF THE ILLUSTRATED EMBODIMENTS

The following description is provided to enable any person skilled in the art to make and use the invention, and is provided in the context of a particular application and its requirements. Various modifications to the embodiments will be readily apparent to those skilled in the art, and the generic principles defined herein may be applied to other embodiments and applications without departing from the spirit and scope of the invention. Thus, the present invention is not intended to be limited to the embodiments shown, but is to be accorded the widest scope consistent with the principles, features and teachings disclosed herein.

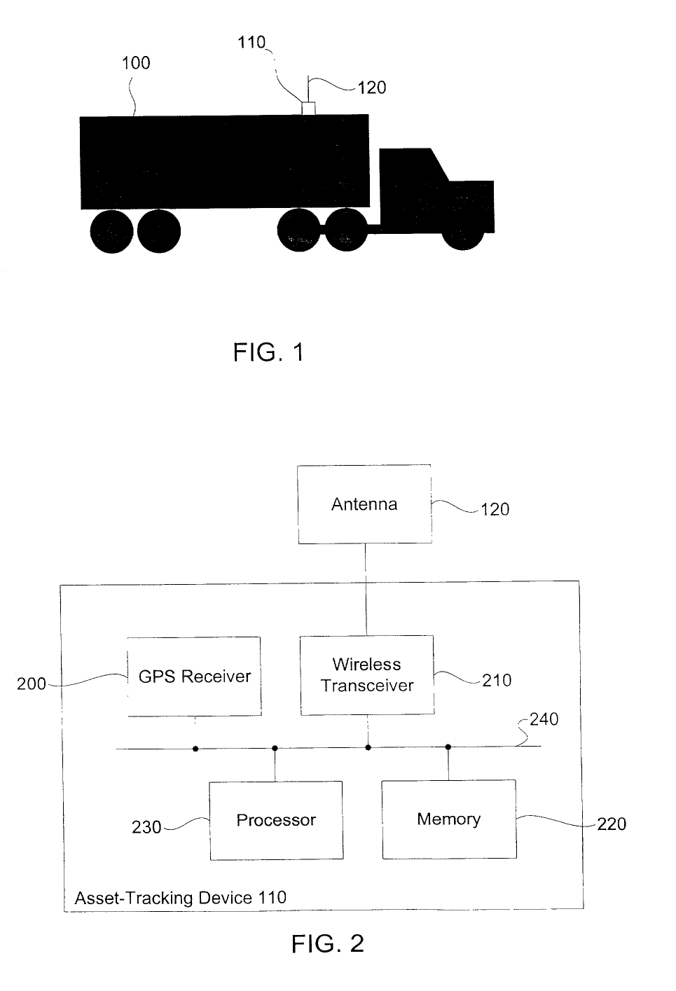

FIG. 1 is a diagram illustrating an example remote asset 100 having a management/monitoring device 110 installed thereon according to an embodiment of the invention. Device 110 performs asset management and/or monitoring applications, such as position reporting and theft reporting to a monitoring station (not shown). Device 110 includes an antenna 120 enabling device 110 to communicate via at least two different wireless networks (not shown). Example asset 100 is a commercial trailer coupled to a truck. In other embodiments of the invention, asset 100 may include other assets, such as automobiles, freight containers, computers, etc.

In FIG. 1, device 110 is installed on the top of asset 100. However, in an alternative embodiment, device 110 may be installed anywhere on or in asset 100. Further, antenna 120 may be located on top of the asset 100 or in other positions.

FIG. 2 is a block diagram illustrating details of the remote asset management/ monitoring device 110 of FIG. 1. Device 110 includes a GPS receiver 200; a wireless transceiver 210 capable to wirelessly communicate with at least two different wireless networks; a memory device 220, such as such as a magnetic disk, Random Access Memory (RAM), or other memory device or combination thereof; and a processor 230, such as an ARM 7 microprocessor or a Motorola 68000 microprocessor, all interconnected for communication by a system bus 240. In addition, wireless transceiver 210 is communicatively coupled to antenna 120. It will be appreciated that the term “position” herein is being used to describe a location of an asset in any of three different axes.

GPS receiver 200 receives radio signals from GPS satellites orbiting the Earth. Based on the received signals, the receiver 200 can calculate its position and altitude. The GPS receiver 200 can then forward that data to processor 230 for processing. In an alternative embodiment, a Loran-C radionavigation system receiver or other positioning system maybe incorporated into asset-tracking device 110 in place of or in addition to GPS receiver 200.

Transceiver 210 can wirelessly transmit and receive data via at least two different wireless networks, such as Cellular Digital Packet Data (CDPD) and ARDIS from American Mobile. In another embodiment of the invention, wireless transceiver 210 may be replaced with at least two wireless transceivers, each capable of communicating with a single wireless network. In another embodiment, wireless transceiver 210 may be replaced with a plurality of wireless transceivers, some of which may be capable of communicating with a plurality of wireless networks while others may be capable of only communicating with a single wireless network. Multiple wireless transceivers in these alternative embodiments may be required due to the lack of a single wireless transceiver capable of communicating with a plurality of wireless networks.

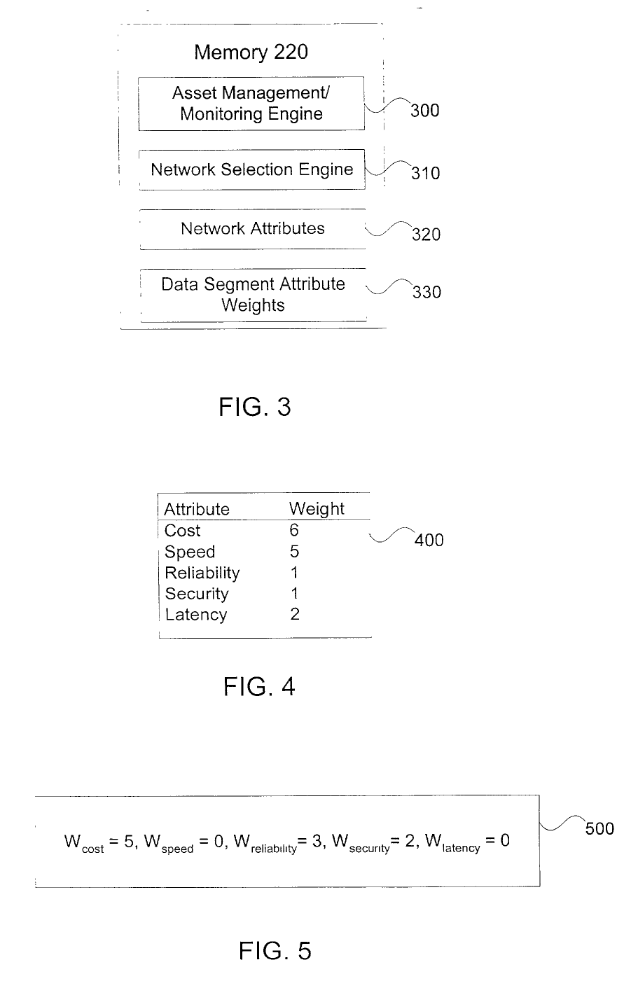

Processor 230 executes engines stored in memory 220 to perform remote-asset management/monitoring applications and to perform wireless network selection based on network attributes and data segment attribute weights, as will be discussed further in conjunction with FIGS. 3-6.

FIG. 3 is a block diagram of memory device 220 according to an embodiment of the invention. Memory 220 stores an asset management/monitoring engine 300; a network selection engine 310; a network attributes file 320; and a data segment attribute weights file 330. Asset management/monitoring engine 300 performs asset management and monitoring functions, such as asset position reporting, asset theft reporting, and other functions. Engine 300 transmits data segments comprising asset position reports and/or other data to a monitoring station or other destination via network selection engine 310, which selects an appropriate wireless network for transmitting the reports and/or data.

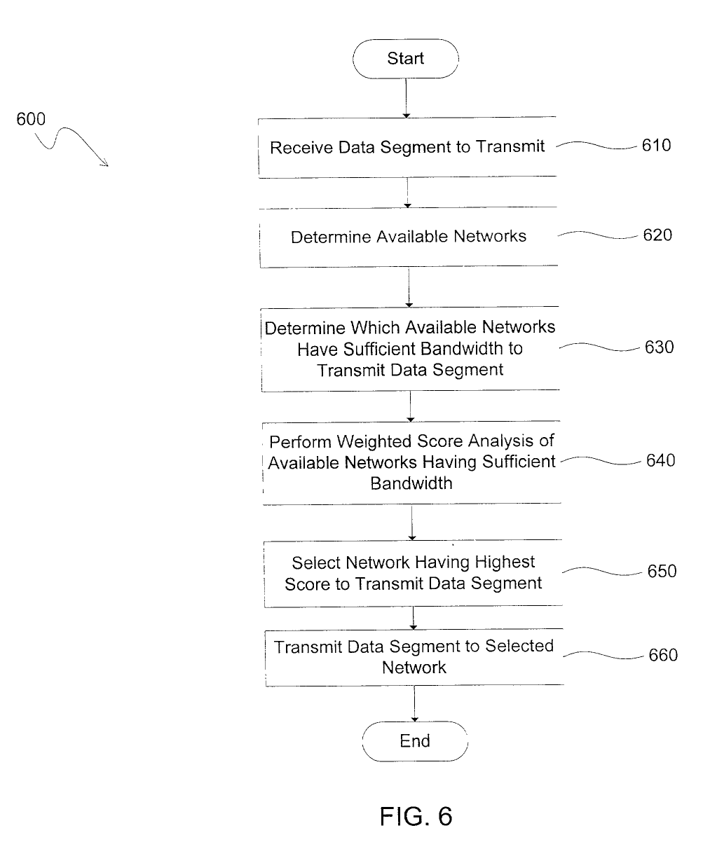

To select a wireless network, network selection engine 310 determines the available wireless networks from the wireless networks supported by wireless transceiver 210; determines which of the available wireless networks have sufficient bandwidth to transmit the reports and/or data; performs a weighted score analysis of available wireless networks having sufficient bandwidth based on attributes of the reports and/or data and attribute weights of the data segment; selects a wireless network having the highest weighted score; and transmits the reports and/or data via wireless transceiver 210 on the selected wireless network. Wireless network selection will be discussed in further detail in conjunction with FIG. 6.

Network attributes 320 holds attributes of all the wireless networks supported by wireless transceiver 210 and will be discussed in further detail in conjunction with FIG. 4. Data segment attribute weights 330 holds attribute weights of all data segment types that asset management/monitoring engine 300 may generate. The attribute weights correspond to a list of network attributes and their relative importance in selecting a wireless network. Data segment attributes weights 330 will be discussed in further detail in conjunction with FIG. 5.

FIG. 4 is a diagram of an example of a table 400 of network attributes for an example wireless network. The example table 400 may be a part of network attributes 320. It will be recognized by one skilled in the art that network attribute data may be maintained in other formats besides tables as illustrated in FIG. 4. For example, network attribute data may be maintained in linked lists or other formats in network attributes 320.

Table 400 includes relative attribute values for five example network attributes: cost/data segment size, speed, reliability, security, and latency. Table 400 may include fewer, different or additional attributes values. The values are ordered such that higher numerical values indicate superior attributes of the wireless network, i.e., attributes values are directly proportional to attribute quality. Alternatively, the attribute values may be ordered such that quality is inversely proportional to the attribute value. The attribute values are pre-defined and may be fixed or updated as wanted to reflect changes in quality of the network attributes. Further, while attribute values in table 400 are listed as integers, the attribute values may also be mixed numbers as expressed by a whole number and a decimal fraction.

In the example table 400, cost and speed have higher values of 6 and 5 respectively, indicating low cost and high speed. However, reliability, security and latency have scores of 1, 1, and 2, respectively, indicating that any data transmitted over the wireless network has a lower likelihood of reaching its destination without being eavesdropped on or otherwise compromised. Accordingly, a wireless network having attribute values of table 400 may be ideal for applications in which the data segment is relatively unimportant as compared to the cost of transmitting the data segment.

FIG. 5 is a diagram of an example data segment attribute weight list 500 from data segment weights file 330. Data segment weights list 500 contains weights for a data segment type indicating the relative importance of network attributes for selecting a wireless network to transmit the data segment type. The list 500, while in this example is shown as a list, may be maintained in data segment attribute weights file 330 in any other format. Further, while attribute weights in list 500 are shown as integers, the attribute weights may also be non-integers, such as mixed numbers expressed by a whole number and a decimal fraction.

Example list 500 includes weights for cost, speed, reliability, security and latency. List 500 may include additional weights or a lesser number of weights. The weights are expressed as being directly proportional to their importance in selecting a wireless network for the data segment. Alternatively, the weights may be expressed as inversely proportional, as long as attributes in network attributes file 320 are also expressed in an inversely proportional format.

In example list 500, the weight for cost is 5, indicating this is a relatively important factor in selecting a wireless network to transmit this data segment, while the weight for speed is 0, indicating that speed of the wireless network is unimportant. Similarly, the weight for latency is 0, indicating latency as an attribute for selecting a wireless network is unimportant. The weights for reliability and security are 3 and 2, respectively, indicating that reliability and security are somewhat important attributes in selecting a wireless network. Accordingly, the weights of list 500 may be for an hourly reported asset location data segment type, in which cost is an important factor but speed is not. If a data segment was a theft reporting data segment type, then speed and reliability attributes may have higher weights while the cost attribute weight might be lower.

FIG. 6 is a flowchart of a method 600 for selecting a wireless network to transmit a remote asset management/monitoring data segment to a monitoring station or other destination. In an embodiment of the invention, network selection engine 310 may perform method 600. First, a data segment to transmit over a wireless network to a corporation is received (610) from, for example, asset management/monitoring engine 300. The data segment can be of any type and length and may include information identifying data segment type.

Next, from the wireless networks supported, by, for example, wireless transceiver 210, it is determined (620) which wireless networks are available to transmit the data segment. Not all supported wireless networks may be available since a wireless network may be down undergoing repairs, out of range, or unavailable for other reasons.

After determining (620) which wireless networks are available, which of the available wireless networks have sufficient bandwidth to transmit the data segment is determined (630). Next, a weighted scored analysis is performed (640) of the available wireless networks having sufficient bandwidth. The weighted score for an available wireless network having sufficient bandwidth is calculated linearly, as Score_{network}

$${Score}_{network} = {\sum }_{1}^{n} {W}_{n} \times {A}_{{network}_{n}} ,$$

wherein n is the number of attributes per network (i.e., n=5 in example table 400 and list 500), Wₙ, are the attribute weights for the data segment (i.e., for list 500: W₁=5; W₂=0; W₃=3; W₄=2; W₅=0) and A_{network n} are the attribute values for the wireless network (i.e., for table 400: A_{=6;} A₂=5; A₃=1; A₄=1; A₅=2). Data segment attribute weights Wₙ are based on data segment type. Weights may come from, for example, data segment attribute weights 330, which holds attribute weights for different types of data segments, such as emergency data segments and routine reporting data segments. Alternatively, asset management/monitoring engine 300 may generate and supply attribute weights for a data segment when the engine 300 sends the data segment to the network selection engine 310.

In an alternative embodiment of the invention, the weighted score may be calculated exponentially, i.e., Score_{network}

$${Score}_{network} = {\sum }_{1}^{n} {A}_{{network}_{n}} \times {2}^{( Wn - 1 )} ,$$

which may help to ensure that the wireless network having the most desirable attributes is selected. In other embodiments of the invention, other weighted scoring algorithms may be used.

After the weighted score analysis is performed (640), the wireless network having the highest weighted score is selected (650). The data segment is then transmitted to a monitoring station or other destination via the selected wireless network. The method then ends.

The foregoing description of the preferred embodiments of the present invention is by way of example only, and other variations and modifications of the above-described embodiments and methods are possible in light of the foregoing teaching. For example, an exponential weighted score algorithm or other non-linear algorithm may be used in place of a linear weighted score algorithm. Further, components of this invention may be implemented using a programmed general purpose digital computer, using application specific integrated circuits, or using a network of interconnected conventional components and circuits. Connections may be wired, wireless, modem, etc. The embodiments described herein are not intended to be exhaustive or limiting. The present invention is limited only by the following claims.

What is claimed is:

1. A method, comprising:
determining availability of wireless networks supported by an asset monitoring device;
performing a weighted score analysis of the available wireless networks as a function of network attributes and data segment attribute weights; and
selecting one of the available wireless networks to transmit a data segment based on the weighted score analysis.

2. The method of claim 1, wherein the selecting selects a wireless network having a highest weighted score.

3. The method of claim 1, wherein the selecting selects a wireless network having a lowest weighted score.

4. The method of claim 1, wherein the weighted score analysis uses a linear weighted score algorithm.

5. The method of claim 1, wherein the weighted score analysis uses an exponential weighted score algorithm.

6. The method of claim 1, wherein the network attributes include cost, speed, reliability, security, and latency.

7. The method of claim 1, further comprising transmitting the data segment over a selected wireless network.

8. The method of claim 1, wherein the available wireless networks have been predetermined to have sufficient bandwidth to transmit the data segment.

9. A machine-readable medium having stored thereon instructions to cause an asset monitoring device to:
determine availability of wireless networks supported by the asset monitoring device;
perform a weighted score analysis of the available wireless networks as a function of network attributes and data segment attribute weights; and
select one of the available wireless networks to transmit a data segment based on the weighted score analysis.

10. The machine-readable medium of claim 9, wherein the instruction to select selects a wireless network having a highest weighted score.

11. The machine-readable medium of claim 9, wherein the instruction to select selects a wireless network having a lowest weighted score.

12. The machine-readable medium of claim 9, wherein the weighted score analysis uses a linear weighted score algorithm.

13. The machine-readable medium of claim 9, wherein the weighted score analysis uses an non-linear weighted score algorithm.

14. The machine-readable medium of claim 9, wherein the network attributes include cost, speed, reliability, security, and latency.

15. The machine-readable medium of claim 9, further comprising an instruction to transmit the data segment over a selected wireless network.

16. The machine-readable medium of claim 1, wherein the available wireless networks have been predetermined to have sufficient bandwidth to transmit the data segment.

17. An asset monitoring device, comprising:
means for determining availability of wireless networks supported by an asset monitoring device;
means for performing a weighted score analysis of the available wireless networks as a function of network attributes and data segment attribute weights; and
means for selecting one of the available wireless networks to transmit a data segment based on the weighted score analysis.

18. A remote asset monitoring device, comprising:
a remote asset monitoring engine capable to generate remote asset monitoring data segments to transmit over a wireless network;
a network attributes file capable to store attributes of wireless networks supported by the device;
a data segment attribute weights file capable to store attribute weights for data segment types generated by the remote asset monitoring engine;
a network selection engine, communicatively coupled to the remote asset monitoring engine, the network attributes file, and the data segment attribute weights file, capable to:
determine availability of the wireless networks supported by the device;
determine which of the available wireless networks have sufficient bandwidth to transmit a data segment;
perform a weighted score analysis of the available wireless networks having sufficient bandwidth as a function of
network attributes from attributes in the network attributes file and
data segment attribute weights for a generated data segment type using weights stored in the data segment attribute weights file; and
select a wireless network to transmit the data segment based on the weighted score analysis.

19. The device of claim 18, wherein the network selection engine selects a wireless network having a highest weighted score.

20. The device of claim 18, wherein the network selection engine selects a wireless network having a lowest weighted score.

21. The device of claim 18, wherein the network selection engine uses a linear weighted score algorithm to perform the weighted score analysis.

22. The device of claim 18, wherein the network selection engine uses an noon-linear weighted score algorithm to perform the weighted score analysis.

23. The device of claim 18, wherein the network attributes include cost, speed, reliability, security, and latency.

24. The device of claim 18, wherein the network selection engine is further capable to transmit the data segments over a selected wireless network.
